(19) United States
(12) Patent Application Publication
(10) Pub. No.: US 2025/0347883 A1
(43) Pub. Date: Nov. 13, 2025

(54) FIBER OPTIC CASSETTE CONFIGURED TO RECEIVE A MULTIFIBER CONNECTOR THAT IS CONFIGURED TO PROVIDE NETWORK REDUNDANCY AND/OR INCREASED FIBER DENSITY

(71) Applicant: BELDEN CANADA ULC, Saint-Laurent (CA)

(72) Inventor: Massimo P. CARBONI, Montreal (CA)

(73) Assignee: BELDEN CANADA ULC, Saint-Laurent (CA)

(21) Appl. No.: 19/202,945

(22) Filed: May 8, 2025

Related U.S. Application Data
(60) Provisional application No. 63/644,002, filed on May 8, 2024.

(51) Int. Cl. G02B 6/44; G02B 6/38

(52) U.S. Cl. CPC G02B 6/4453; G02B 6/3893

(57) ABSTRACT

A fiber optic cassette may be configured to receive a multifiber connector that may provide network redundancy and increased fiber density. The fiber optic cassette may have an electronic component and a fiber optic adapter portion having a port portion configured to receive a very small form factor (VSFF) connector. The port portion of the fiber optic adapter may optically couple two fibers of the VSFF connector with two optical fibers. The electronic component may optically couple the two optical fibers with a single optical fiber. The electronic component may alternatively merge optical signals from the two optical fibers to the single optical fiber or split an optical signal from the single optical fiber to the two optical fibers so as to provide network redundancy of electronic components optically coupled in parallel to the port by the VSSF connector and/or to increase fiber density of the cassette.

### CROSS REFERENCE TO RELATED APPLICATION

This application claims the benefit of U.S. Provisional Application No. 63/644,002, filed on May 8, 2024, which is currently pending, the disclosure of which is hereby incorporated by reference herein in its entirety.

### TECHNICAL FIELD

The present disclosure is directed to a connector for a distributed network and, more particularly, to a multifiber connector configured to operate with a fiber optic cassette to provide network redundancy and/or increased fiber density, which may enhance cable management and/or deployment speed.

### BACKGROUND

As greater volumes of data and signals are employed in the everyday lives of people in residential, commercial, and industrial settings, distributed networks have been installed. Over time, advancements in technology have allowed for the expansion and upgrading of portions of distributed networks in a variety of settings. Such advancements have provided a variety of different cable connectors to service various cable connection configurations.

Despite a variety of possible connectors to terminate cables of a distributed network, devices, and interconnects that comprise a distributed network may be restricted to particular connectors that are inefficient and/or sub-optimal relative to other available connectors. As such, an evolution of connector and/or cable density is needed to accommodate splitters and aggregation switches to provide redundancy and/or output needs of multiple dwelling units, smart buildings, healthcare buildings, and education environments. It follows an industry trend of a need for higher density cables and connectors, along with more efficient installation, to provide redundancy and polarity management.

It may be desirable to provide a fiber optic cassette configured to receive a multifiber connector that is configured to provide network redundancy and/or increased fiber density. In some aspects, it may be desirable to provide a fiber optic cassette that provides connector options that include a very small form factor connection, which can promote cable organization and efficient cable polarity management while allowing greater cable density into, and/or out of, the cassette.

### SUMMARY

In accordance with various aspects of the disclosure, a fiber optic cassette may receive a multifiber connector to provide network redundancy and/or increased fiber density. The fiber optic cassette may have a housing portion, a fiber optic adapter portion, a fiber optic connection port portion, and an electronic component. The fiber optic adapter portion may be disposed at an end wall portion of the housing portion. The fiber optic connection port portion may be disposed at the end wall portion of the housing portion. The electronic component may be disposed in the housing portion. The fiber optic adapter may have a very small form factor (VSFF) port portion that may receive a VSFF duplex connector. The VSFF port portion of the fiber optic adapter portion may optically couple two fibers of the VSFF duplex connector with two optical fibers in the housing portion. The fiber optic connection port portion may receive a simplex fiber optic connector and to optically couple a fiber of the fiber optic connector with a single optical fiber in the housing portion. The electronic component may optically couple the two optical fibers with the single optical fiber. The electronic component may alternatively operate as an aggregation portion that may merge optical signals from the two optical fibers to the single optical fiber or as a splitter portion that may split an optical signal from the single optical fiber to the two optical fibers so as to provide network redundancy of two matching electronic peripherals optically coupled in parallel to the port by the VSSF connector and/or to increase fiber density of the cassette.

In some embodiments of the foregoing fiber optic cassette, the electronic component may be configured to operate as the aggregation portion.

In some embodiments of the foregoing fiber optic cassettes, the VSSF port portion may be configured to receive a VSFF connector that is optically coupled with two matching electronic peripherals that are configured to operate in parallel, and the electronic component may be configured to merge optical signals from the two optical fibers to the single optical fiber so as to provide network redundancy with the two matching electronic peripherals.

In some embodiments of the foregoing fiber optic cassettes, the electronic component may be configured to operate as the splitter portion.

In some embodiments of the foregoing fiber optic cassettes, the electronic component may be configured to split an optical signal from the single optical fiber to the two optical fibers to increase fiber density of the cassette.

In some embodiments of the foregoing fiber optic cassettes, the fiber optic connection port may be configured to receive a simplex SC connector or a simplex LC connector.

In accordance with various aspects of the disclosure, a fiber optic cassette may be configured to receive a multifiber connector that is configured to provide network redundancy and/or increased fiber density with a fiber optic adapter portion, a fiber optic connection port, and an electronic component. The fiber optic adapter portion may have a port portion configured to receive a very small form factor (VSFF) duplex connector. The fiber optic connection port portion may receive a fiber optic connector. The electronic component may be disposed in a housing portion. The port portion of the fiber optic adapter may optically couple two fibers of the VSFF duplex connector with two optical fibers in the housing portion. The fiber optic connection port may optically couple a fiber of a fiber optic connector with a single optical fiber in the housing portion. The electronic component may optically couple the two optical fibers with the single optical fiber. The electronic component may alternatively merge optical signals from the two optical fibers to the single optical fiber or split an optical signal from the single optical fiber to the two optical fibers so as to provide network redundancy of electronic components optically coupled in parallel to the port by the VSSF connector and/or to increase fiber density of the cassette.

In some embodiments of the foregoing fiber optic cassettes, the electronic component may be configured to operate as the aggregation portion.

In some embodiments of the foregoing fiber optic cassettes, the port portion may be configured to receive a VSFF connector that is optically coupled with two matching electronic peripherals that are configured to operate in parallel, and wherein the electronic component may be configured to merge optical signals from the two optical fibers to the single optical fiber so as to provide network redundancy with the two matching electronic peripherals.

In some embodiments of the foregoing fiber optic cassettes, the electronic component may be configured to operate as a splitter portion.

In some embodiments of the foregoing fiber optic cassettes, the electronic component may be configured to split an optical signal from the single optical fiber to the two optical fibers to increase fiber density of the cassette.

In some embodiments of the foregoing fiber optic cassettes, the fiber optic connection port may be configured to receive an SC connector or an LC connector.

In some embodiments of the foregoing fiber optic cassettes, the fiber optic connection port may be configured to receive a simplex SC connector or a simplex LC connector.

In accordance with various aspects of the disclosure, a fiber optic cassette may be configured to receive a multifiber connector that may provide network redundancy and increased fiber density. The fiber optic cassette may have an electronic component and a fiber optic adapter portion having a port portion configured to receive a very small form factor (VSFF) connector. The port portion of the fiber optic adapter may optically couple two fibers of the VSFF connector with two optical fibers. The electronic component may optically couple the two optical fibers with a single optical fiber. The electronic component may alternatively merge optical signals from the two optical fibers to the single optical fiber or split an optical signal from the single optical fiber to the two optical fibers so as to provide network redundancy of electronic components optically coupled in parallel to the port by the VSSF connector and/or to increase fiber density of the cassette.

In some embodiments of the foregoing fiber optic cassettes, the electronic component may be configured to operate as the aggregation portion.

In some embodiments of the foregoing fiber optic cassettes, the port portion may be configured to receive the VSFF connector that is optically coupled with two matching electronic peripherals that are configured to operate in parallel, and the electronic component may be configured to merge optical signals from the two optical fibers to the single optical fiber so as to provide network redundancy with the two matching electronic peripherals.

In some embodiments of the foregoing fiber optic cassettes, the electronic component may be configured to operate as a splitter portion.

In some embodiments of the foregoing fiber optic cassettes, the electronic component may be configured to split an optical signal from the single optical fiber to the two optical fibers to increase fiber density of the cassette.

In some embodiments of the foregoing fiber optic cassettes, the port portion may be configured to receive an SC connector or an LC connector.

In some embodiments of the foregoing fiber optic cassettes, the port portion may be configured to receive a simplex SC connector or a simplex LC connector.

### BRIEF DESCRIPTION OF THE DRAWINGS

Further advantages and features of the present disclosure will become apparent from the following description and the accompanying drawings, to which reference is made.

FIG. 1 illustrates portions of a signal environment in which assorted embodiments can be practiced.

FIG. 2 represents portions of a distributed network that may be employed in the signal environment of FIG. 1 in some embodiments of this disclosure.

FIG. 3 is a line representation of portions of an interconnect that may be utilized in the distributed network of FIG. 2 in various embodiments of this disclosure.

FIG. 4 displays portions of a network interconnect configured and operated in accordance with assorted embodiments of this disclosure.

FIG. 5 illustrates a line representation of an adapter that may be employed with an interconnect in some embodiments of this disclosure.

FIG. 6 displays aspects of a distributed network employing an interconnect in accordance with various embodiments of this disclosure.

FIG. 7 illustrates portions of a distributed network utilizing an interconnect in accordance with assorted embodiments of this disclosure.

### DETAILED DESCRIPTION

Embodiments may provide a fiber optic adapter that is configured for fiber to the x (FTTx) applications and optical local area network deployments. A fiber optic adapter may provide connection options that include a very small form factor ports for input and/or output sides of a network interconnect to allow efficient cable management and heightened cable density. The adapter may be configured as a multifiber connector that may operate with a fiber optic cassette to provide network redundancy and/or increased fiber density, which may enhance cable management and/or deployment speed.

Reference will now be made in detail to presently preferred embodiments and methods of the present disclosure, which constitute the best modes of practicing the present disclosure presently known to the inventors. However, it is to be understood that the disclosed embodiments are merely exemplary of the present disclosure that may be embodied in various and alternative forms. Therefore, specific details disclosed herein are not to be interpreted as limiting, but merely as a representative basis for any aspect of the present disclosure and/or as a representative basis for teaching one skilled in the art to variously employ the present disclosure.

It is also to be understood that this present disclosure is not limited to the specific embodiments and methods described below, as specific components and/or conditions may, of course, vary. Furthermore, the terminology used herein is used only for the purpose of describing particular embodiments of the present disclosure and is not intended to be limiting in any way.

Distributed networks have evolved over time to provide data bandwidth to a large number of people. Advancements in cabling, devices, and interconnects have allowed distributed networks to continue to evolve and provide greater reliability, speed, and security to residential, commercial, and industrial sites. Despite improvements in cabling and interconnect aspects of a distributed network, cable management and interconnect connection density remain relatively inefficient. The availability of a variety of interconnect connectors with different sizes and capabilities have yet to be standardized and, as such, installation and updating operations that involve cabling of a distributed network may be sub-optimal.

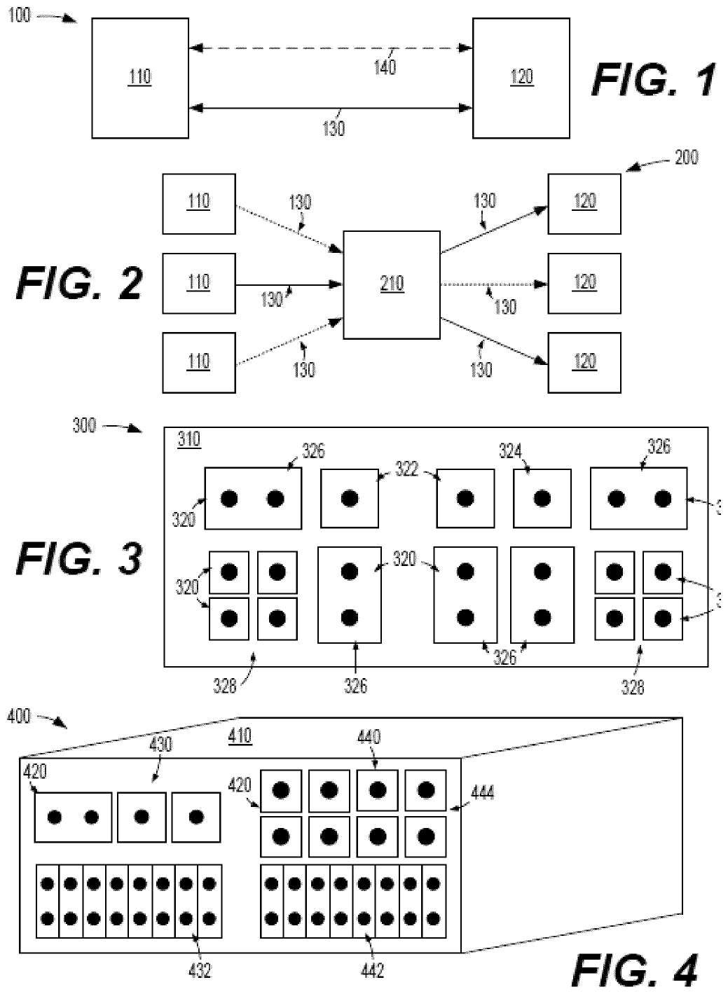

FIG. 1 is a block representation of a signal environment 100 in which assorted embodiments of the present disclosure may be practiced. Any number and type of signal may be generated, transmitted, stored, and retrieved by a source 110 and a destination 120. Such signals may be transmitted in a single direction, as illustrated by arrow 102, or bidirectionally, as illustrated by arrows 104, via one or more wired signal pathways 130, which may be characterized as a cable. It is noted that a cable may utilize any number, and type, of signal conductor, such as a wired conductor or optical conductive core. However, some embodiments transfer signals via a wireless signal pathway 140.

The connection of a source 110 to a destination 120 may allow for efficient distribution of data signals. Additional signal pathways 130/140 may be employed to concurrently, redundantly, or sequentially transfer greater volumes of data. While the signal carrying capabilities of the signal environment 100 may be scaled to accommodate demand for greater speed and/or volume of transferred data, practical application and installation of wired signal pathways 130 and/or wireless signal pathways 140 may pose challenges. For instance, the placement of cables over relatively long distances and/or into facilities may necessitate use of physically separate cables that are operably joined to form one or more reliable signal pathways 130 between sources 110 and destinations 120.

FIG. 2 is a block representation of portions of a distributed network 200 that may provide the signal environment 100 of FIG. 1 in accordance with various embodiments. As shown, a number of separate sources 110 are connected to a number of separate destinations 120 via separate cables 130 that are joined by an interconnect 210. An interconnect 210 is not limited to a particular device, capability, or size, but may provide a termination of multiple cables 130 that are utilized to form one or more reliable signal pathways. It is noted that any number of similar, or dissimilar, interconnects 210 may be employed as part of the distributed network 200 to facilitate data passing between selected sources 110 and destinations 120.

An interconnect 210, in some embodiments, may be structurally configured with a different number of outputs that inputs. That is, the number of cables 130, and corresponding signal pathways, entering the interconnect 210 may be greater than, or less than, the number of cables 130 exiting the interconnect 210 as output signals. As such, the interconnect 210 may be characterized as a splitter that outputs more signals than it receives or inputs more signals than it transmits out. Other embodiments of an interconnect 210 provide a multitude of input and output ports that may be selectively engaged by cables 130 in a variety of arrangements that correspond with similar, or dissimilar, numbers of input signals relative to output signals, which may be characterized as a switch.

With the capability to utilize one or more interconnects 210 to join separate cables 130 into a variety of different configurations that allow a range of different sources 110 communicate with a range of different destinations 120, the distributed network 200 may provide adaptability that is conducive to optimal signal speed and reliability over time. The non-limiting network 200 shown in FIG. 2 illustrates, with solid lined cables 130, how a single interconnect 210 can connect a single source 110 to multiple destinations 120 while other cables 130 (segmented lines) illustrate how multiple sources 110 may connect to a single destination 120 via the interconnect 210.

Although the interconnect 210 may be arranged in a variety of configurations to join any number, and type, of cables 130 to form one or more continuous signal pathway from sources 110 to destinations 120, the distributed network 200 may have issues corresponding with inefficiency. For instance, installation of an interconnect 210 may be inefficient as the connectivity capabilities of the interconnect 210 require cables 210 to be terminated with particular connectors, such as SC or LC type connectors. Operation of the interconnect 210 may additionally pose inefficiencies in the organization of cables 130 that are joined by the interconnect 210 along with inefficiencies in altering cable polarity for multi-channel cable 130 configurations, such as duplex or quad configurations.

FIG. 3 illustrates portions of an interconnect 300 that may be utilized in the distributed network 200 of FIG. 2 and signal environment 100 of FIG. 1 in various embodiments. The interconnect 300 has a housing 310 that provides structural support and environmental protection for circuitry and/or connection features, such as splitter, splices, adapters, and connectors, that facilitate joining separate cables 130. The housing 310 may engage assorted separate cables 130 via ports 320 that are structurally configured to support and secure cable connectors. In the non-limiting embodiment shown in FIG. 3, the housing 310 provides a variety of different ports 320, but a single type or size of port 320 may alternatively be employed to connect separate cables 130.

With the ability to configure the interconnect housing 310 with any number, and type, of ports 320, the interconnect 300 may provide a diverse variety of connectivity capabilities. For instance, different sizes and types of connectors may be facilitated with separate ports 320, such as the SC port 322 and LC port 324. Additionally, the interconnect housing 310 may allow for various multi-channel connections, such as duplex ports 326 and quad ports 328, which allow for bidirectional data transfer. However, the use of some ports 320 may inhibit connection density in the interconnect housing 310. That is, some ports 320 have a physical size that occupies a relatively large amount of the available space on the housing 310, which reduces the available port 320 density for the interconnect 300.

With interconnect port 320 configurations where a single type of connector is employed, such as an SN connector, the number of cables 130, and connections, facilitated by the interconnect 300 may increase. Yet, the connectivity of the interconnect 310 may be inefficient compared to port 320 configurations that allow different types of connectors. That is, a single type of port 320 may accommodate greater numbers of cables 130, but may be inefficient for installation and rework operations that utilize cables 130 with different connectors, which would require cables 130 to be altered to provide a connector to match the available port 320. It is contemplated that the interconnect 300 may be structurally configured to provide redundant, or optional, ports 320 that have differing capabilities and/or sizes, but such arrangement reduces effective port 320 density of the interconnect 300 and, effectively, guarantees unused aspects of the interconnect 300.

In sum, the interconnect 300 may be structurally configured with a single type of connector ports 320 or a variety of different types of ports 320, but has yet to be arranged to provide high connectivity and port density that is conducive to efficient installation and cable management during operation. Accordingly, various embodiments arrange an interconnect with different ports 320 that provide connectivity options without degrading port 320 density by employing relatively small form factor ports 320.

FIG. 4 illustrates aspects of an interconnect 400 constructed and operated in accordance with some embodiments to provide a balance of port connectivity, density, polarity management, and cable management. The interconnect 400 has a housing 410 that allows it to be utilized in a variety of different locations as part of a distributed network. The interconnect housing 410 may enclose circuitry, splitters, adapters, connectors, and splices that join separate cables 130 to form signal pathways through the interconnect 400. Such assorted connection features that allow for the joining of separate cables may be electrically connected to a variety of ports 420 that are organized as input ports 430 and output ports 440 that respectively correspond with opposite sides of the connection features that utilize one or more cables connected to input ports 430 and one or more cables connected to an output port 440.

The non-limiting embodiment of the interconnect 400 shown in FIG. 4 conveys how a variety of different ports 420 are available for input and output. The availability of different types of ports 420 increases the connectivity of the interconnect 400 while utilizing physically small form factor ports 432/442 allows for increased port density that counteracts the presence of potentially unused ports 420. That is, the presence of different types of ports 420 provides connection options for connecting different cables to the respective input 430 or output 440 ports while the use of very small form factor (VSFF) ports 432/442 provides a relatively high port 420 density for the interconnect 400 despite, potentially, having unutilized input ports 430 or output ports 440.

The balance of connectivity and port 420 density is complemented by the cable and polarity management provided by the VSFF ports 432/442. For instance, the size and position of the VSFF ports 432/442 allows for cables 130 to be efficiently supported, attached, grouped, or otherwise organized externally from the interconnect housing 410. The use of duplex configurations for each of the VSFF ports 432/442 allows for efficient polarity management as connectors can be simply flipped to reverse polarity. It is noted that while the VSFF ports 432/442 are illustrated as duplex configurations, such arrangement is not required and a very small form factor port may be incorporated into the interconnect 400 with simplex, duplex, or quad configurations.

With the combination of VSFF ports 432/442 and optional ports 434/444, the interconnect 400 allows for a diverse variety of cable connections without sacrificing connection density. It is noted that the optional ports 434/444 may be engaged concurrently with the VSFF ports 432/442. Some embodiments of the interconnect 400 structurally configure the optional ports 434/44 with very small form factors while other embodiments utilize matching, or dissimilar, types of ports 420 for optional connectivity for input cables and/or output cables. As a result of the port 420 arrangement that includes VSFF ports 432/442 and optional ports 434/444, the interconnect 400 provides efficient cable and polarity management in combination with a diverse variety of cable connection options.

For clarity, optical fiber splitters may either have a 1:x or an x:1 split ratio where a fiber optic connection is split into multiple connections. For example, in a 1:8 case, we have 1 fiber optic cable that gets split through a “PLC” and the signal is then distributed across 8 fibers. The opposite is true in a 2:1 splitter where 2 fiber optic cables are merged into 1. The split ratios for the input and output can vary, just as for aggregation switches. It is noted that an aggregation switch is a networking device that allows multiple network connections to be bundled together into a single link.

Through the use of a customized adapter 500, dense multifiber connectors may be utilized on the input of the splitter, which corresponds to enhanced redundance on an active equipment side. Generally, two active equipment may be running in parallel across 2 fibers that are then merged into one. Hence, the most popular 2:1 split ratio. Having a dense multifiber connector helps with the density on the input of the cassette as well as cable management. On the density side, the footprint of the fiber optic adapter may be reduced by 3× using these smaller form factor connectors. On the cable management side as well, 2 fiber mini distribution cables can be used, which take up less space than traditional zip cord or traditional 1 fiber simplex cable. As a result, cable management and polarity management can be improved for higher density while providing an option for having multiple 2:1 splitter in the same cassette due to density advantage and smaller footprints.

For the output side, the concept is similar. Higher density options allow for more connections in the main distribution frame. Consequentially, easier and quicker deployment in aggregation area is provided. Such deployment is beneficial when upgrading existing infrastructure, for instance. In the event of upgrading from copper switches, all the current copper deployment can be kept, and the copper switches can be replaced by fiber ONTs or other aggregation switches. Having the use of these dense very small form factor multifiber connectors can help with deployment speed, polarity management, allow for denser MDFs, and allow for more connections on a single apparatus (splitter or switch).

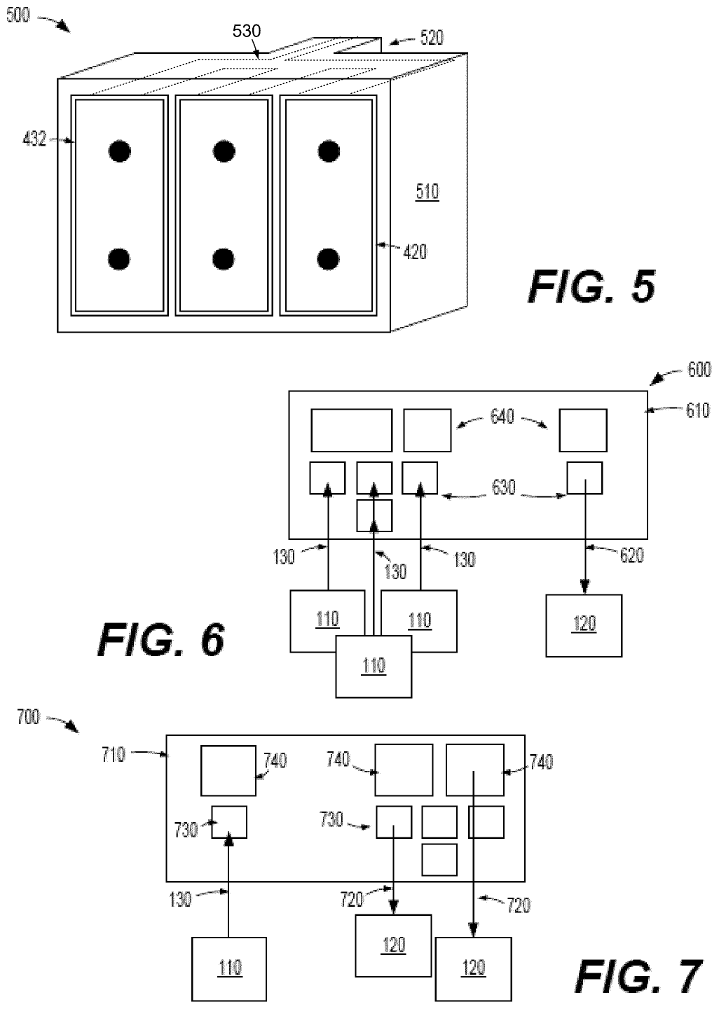

FIG. 5 displays a line representation of an adapter 500 that may be employed with an interconnect 300/400 as part of a distributed network. The adapter 500 has a unitary housing 510 that presents a side with female ports 420 and a side with one or more male connectors 520. The presence of both male and female aspects allows the adapter 500 to be utilized to connect a terminated cable or port of another device to an interconnect 300/400. In some embodiments, the adapter 500 presents female ports 420 on opposite sides to allow cables terminated with matching, or dissimilar, connectors to be employed. It is noted that the adapter housing 510 may be characterized as a aggregation portion configured to receive a plurality of input fibers and merge signals into a single output fiber.

While not required, the adapter 500 may be structurally configured to provide different types of ports 420, which eliminates the need to rework a terminated cable during installation. For instance, a cable terminated with a simplex, or duplex, SC connector, or LC connector, that does not match a port of an interconnect may, instead, engage a compatible adapter port 420 while the male connector 520 electrically engages the interconnect. The ability to utilize the adapter 500 allows for the efficient translation of a cable without having to actually change the cable connector or termination configuration to engage an interconnect provides practical efficiencies. A non-limiting example of the adapter 500 may translate a duplex cable configuration into a simplex or quad configuration. Other examples of the adapter 500 may translate two separate simplex cables into a single duplex configuration.

In some embodiments, the adapter 500 is configured as a very small form factor (VSFF) component that supports more than 1 duplex portion and/or another VSFF port, such as a quad port. Other embodiments of the adapter 500 provide different aggregation ratios, such as four inputs to two outputs, eight inputs to four outputs, or other combinations to provide desired redundancy. As illustrated with segmented lines, the adapter 500 may be configured with an electronic component 530 that may optically couple two optical fibers with a single optical fiber. The electronic component 530, in some embodiments, may operate as an aggregation portion that may merge optical signals from two optical fibers to a single optical fiber. While not limiting, the electronic component 530 may be configured as an aggregation portion, or a splitter, which may be characterized as a splitter portion, that splits an optical signal from a single optical fiber to two optical fibers, which may provide network redundancy of two matching electronic peripherals optically coupled in parallel via a port 432 of the adapter 500. As a result, the adapter 500 may provide increased fiber density for an interconnect 400.

FIG. 6 illustrates aspects of a distributed network 600 that utilizes an interconnect 610 in accordance with various embodiments to combine separate input cables 130 into a single output cable 620. By employing input ports of the interconnect 610, separate devices may be joined with a common output signal pathway. Such configuration may provide redundancy capabilities for the distributed network 600 with greater cable and polarity management. Other embodiments of the distributed network 600 may concurrently provide splitter and splice connection features. The use of VSFF ports 630 in the interconnect 610 allows for a smaller physical footprint for the interconnect 610 while optional interconnect ports 640 allows for efficient cable installation without having to rework a cable's termination configuration. VSFF ports 630 may further be utilized for ports that are “on-call” and available without being currently active, which allows for efficient switching in the event of a failure or perceived need for an additional active port.

Just as the input ports of the interconnect 610 may be employed to provide distributed network 600 efficiency in a smaller physical footprint, the output ports of the interconnect 610 may be structurally configured to provide VSFF ports along with at least one optional port. FIG. 7 illustrates aspects of a distributed network 700 with an interconnect 710 employed in accordance with various embodiments to provide relatively high density deployment of multiple output cables 720. The utilization of VSFF output ports of the interconnect 710 allows relatively large numbers of downstream devices to be connected from as few as one input cables, which allows for efficient distribution of signals. In some embodiments, such as overlayed passive optical networks, an interconnect 710 may have 2:x input ports to output ports, which is suitable to link primary and secondary optical line terminal (OLT) systems.

In a non-limiting example, the interconnect 710 may split a single input cable 130 into many downstream optical network terminal destinations 120 via multiple output cables 720. The ability to utilize VSFF 730 and/or optional 740 output ports of the interconnect 710 allows a technician to efficiently install the assorted cables without having to attach different connectors to terminate one or more cables. With the ability to deploy fiber optic cables with duplex terminal configurations with the interconnect 710, the distributed network 700 may have efficient redundancy, cabling management, polarity management, and connector density in a relatively small physical footprint.

Additional embodiments include any one of the embodiments described above, where one or more of its components, functionalities or structures is interchanged with, replaced by or augmented by one or more of the components, functionalities or structures of a different embodiment described above. It should be understood that various changes and modifications to the embodiments described herein will be apparent to those skilled in the art. Such changes and modifications can be made without departing from the spirit and scope of the present disclosure and without diminishing its intended advantages. It is therefore intended that such changes and modifications be covered by the appended claims.

Although several embodiments of the disclosure have been disclosed in the foregoing specification, it is understood by those skilled in the art that many modifications and other embodiments of the disclosure will come to mind to which the disclosure pertains, having the benefit of the teaching presented in the foregoing description and associated drawings. It is thus understood that the disclosure is not limited to the specific embodiments disclosed herein above, and that many modifications and other embodiments are intended to be included within the scope of the appended claims. Moreover, although specific terms are employed herein, as well as in the claims which follow, they are used only in a generic and descriptive sense, and not for the purposes of limiting the present disclosure, nor the claims which follow.

What is claimed is:

1. A fiber optic cassette configured to receive a multifiber connector that is configured to provide network redundancy and/or increased fiber density, comprising:
a housing portion;
a fiber optic adapter portion disposed at an end wall portion of the housing portion;
a fiber optic connection port portion disposed at the end wall portion of the housing portion;
an electronic component disposed in the housing portion;
wherein the fiber optic adapter includes a very small form factor (VSFF) port portion configured to receive a VSFF duplex connector;
wherein the VSFF port portion of the fiber optic adapter portion is configured to optically couple two fibers of the VSFF duplex connector with two optical fibers in the housing portion;
wherein the fiber optic connection port portion is configured to receive a simplex fiber optic connector and to optically couple a fiber of the fiber optic connector with a single optical fiber in the housing portion;
wherein the electronic component is configured to optically couple the two optical fibers with the single optical fiber;
wherein the electronic component is configured to alternatively operate as an aggregation portion configured to merge optical signals from the two optical fibers to the single optical fiber or as a splitter portion configured to split an optical signal from the single optical fiber to the two optical fibers so as to provide network redundancy of two matching electronic peripherals optically coupled in parallel to the port by the VSSF connector and/or to increase fiber density of the cassette.

2. The fiber optic cassette of claim 1, wherein the electronic component is configured to operate as the aggregation portion.

3. The fiber optic cassette of claim 1, wherein the VSSF port portion is configured to receive a VSFF connector that is optically coupled with two matching electronic peripherals that are configured to operate in parallel; and
wherein the electronic component is configured to merge optical signals from the two optical fibers to the single optical fiber so as to provide network redundancy with the two matching electronic peripherals.

4. The fiber optic cassette of claim 1, wherein the electronic component is configured to operate as the splitter portion.

5. The fiber optic cassette of claim 1, wherein the electronic component is configured to split an optical signal from the single optical fiber to the two optical fibers to increase fiber density of the cassette.

6. The fiber optic cassette of claim 1, wherein the fiber optic connection port is configured to receive a simplex SC connector or a simplex LC connector.

7. A fiber optic cassette configured to receive a multifiber connector that is configured to provide network redundancy and/or increased fiber density, comprising:
a fiber optic adapter portion having a port portion configured to receive a very small form factor (VSFF) duplex connector;
a fiber optic connection port portion configured to receive a fiber optic connector;
an electronic component disposed in a housing portion;
wherein the port portion of the fiber optic adapter is configured to optically couple two fibers of the VSFF duplex connector with two optical fibers in the housing portion;
wherein the fiber optic connection port is configured to optically couple a fiber of a fiber optic connector with a single optical fiber in the housing portion;
wherein the electronic component is configured to optically couple the two optical fibers with the single optical fiber;
wherein the electronic component is configured to alternatively merge optical signals from the two optical fibers to the single optical fiber or split an optical signal from the single optical fiber to the two optical fibers so as to provide network redundancy of electronic components optically coupled in parallel to the port by the VSSF connector and/or to increase fiber density of the cassette.

8. The fiber optic cassette of claim 7, wherein the electronic component is configured to operate as the aggregation portion.

9. The fiber optic cassette of claim 7, wherein the port portion is configured to receive a VSFF connector that is optically coupled with two matching electronic peripherals that are configured to operate in parallel; and
wherein the electronic component is configured to merge optical signals from the two optical fibers to the single optical fiber so as to provide network redundancy with the two matching electronic peripherals.

10. The fiber optic cassette of claim 7, wherein the electronic component is configured to operate as a splitter portion.

11. The fiber optic cassette of claim 7, wherein the electronic component is configured to split an optical signal from the single optical fiber to the two optical fibers to increase fiber density of the cassette.

12. The fiber optic cassette of claim 7, wherein the fiber optic connection port is configured to receive an SC connector or an LC connector.

13. The fiber optic cassette of claim 7, wherein the fiber optic connection port is configured to receive a simplex SC connector or a simplex LC connector.

14. A fiber optic cassette configured to receive a multifiber connector that is configured to provide network redundancy and/or increased fiber density, comprising:
a fiber optic adapter portion having a port portion configured to receive a very small form factor (VSFF) connector;
an electronic component;
wherein the port portion of the fiber optic adapter is configured to optically couple two fibers of the VSFF connector with two optical fibers;
wherein the electronic component is configured to optically couple the two optical fibers with a single optical fiber;
wherein the electronic component is configured to alternatively merge optical signals from the two optical fibers to the single optical fiber or split an optical signal from the single optical fiber to the two optical fibers so as to provide network redundancy of electronic components optically coupled in parallel to the port by the VSSF connector and/or to increase fiber density of the cassette.

15. The fiber optic cassette of claim 14, wherein the electronic component is configured to operate as the aggregation portion.

16. The fiber optic cassette of claim 14, wherein the port portion is configured to receive the VSFF connector that is optically coupled with two matching electronic peripherals that are configured to operate in parallel; and
wherein the electronic component is configured to merge optical signals from the two optical fibers to the single optical fiber so as to provide network redundancy with the two matching electronic peripherals.

17. The fiber optic cassette of claim 14, wherein the electronic component is configured to operate as a splitter portion.

18. The fiber optic cassette of claim 14, wherein the electronic component is configured to split an optical signal from the single optical fiber to the two optical fibers to increase fiber density of the cassette.

19. The fiber optic cassette of claim 14, wherein the port portion is configured to receive an SC connector or an LC connector.

20. The fiber optic cassette of claim 14, wherein the port portion is configured to receive a simplex SC connector or a simplex LC connector.
